(19) United States
(12) Patent Application Publication
(10) Pub. No.: US 2009/0287534 A1
(43) Pub. Date: Nov. 19, 2009

(54) SYSTEM AND METHOD FOR PROVIDING CONTEMPORANEOUS PRODUCT INFORMATION AND SALES SUPPORT FOR RETAIL CUSTOMERS

(76) Inventors: Shang Qing Guo, Cortlandt Manor, NY (US); Sinem Guven, New York, NY (US); Gopal Sarma Pingali, Mohegan Lake, NY (US); Mark Edward Podlaseck, Kent, CT (US); Zon-yin Shae, South Salem, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/120,398

(22) Filed: May 14, 2008

(51) Int. Cl. G06Q 50/00

(52) U.S. Cl. 705/10

(57) ABSTRACT

A system and method for providing contemporaneous product information includes identifying a product by collecting information with a user device, and determining a customer location using information collected by the user device. Based upon the product and the customer location, a sales person qualified to respond to customer questions is identified. A link is established between the customer and the sales person to permit live chat between a sales person and the customer.

### RELATED APPLICATION INFORMATION

This application is related to commonly assigned U.S. patent application Ser. No. TBD (Attorney Docket Number YOR920080202US1 (163-238)), entitled “SYSTEM AND METHOD FOR PROVIDING CONTEMPORANEOUS PRODUCT INFORMATION WITH ANIMATED VIRTUAL REPRESENTATIONS” filed currently herewith, and incorporated herein by reference in its entirety.

### BACKGROUND

1. Technical Field

The present invention relates to product information and more particularly to systems and methods which address the problem of obtaining sales advice and support information about a product in a retail store during shopping.

2. Description of the Related Art

In a retail store environment, there are several challenges faced by shoppers and retailers. Shoppers often find it difficult to get the information they need about a product in the store. Information like how popular the product is, how other consumers are rating/reviewing the product, how experts have reviewed the product, how accurate information on features, functions, accessories, related products, etc. Retailers are often challenged in providing this information to customers.

In-store support personnel (salespeople, advisors, etc.) are expensive and retailers are increasingly unable to provide sufficient personal support to shoppers. Informational product displays are a lower-cost alternative; however, paper displays are limited by the effort needed to keep them up-to-date, their relatively low information value, and, from a merchandising perspective, the fact that they are usually unattractive.

Interactive electronic displays are also being used, but are available only in particular areas of the store due to space constraints. The shopper is not able to get the information they need at the desired moment at any and every product in the store.

Reviews and ratings of products are available on the World Wide Web today, but this information is not readily accessible by the shoppers in retail stores. People may look to cell phones to make calls to other people to obtain information about a product, e.g., from web reviews etc. Others access some of this information from their web-enabled hand-held devices. However, there are several drawbacks here. The shopper may find useful reviews on a competitor's site, which is potentially disastrous for the current purchase or future ones. Also, the product under consideration in the store may not be available online, or may be hard to find online. Moreover, web searching and browsing for additional information occurs through interfaces which are not necessarily under the store's control, and are disruptive to a well-designed and consistently-branded shopping experience.

Shoppers are not able to provide their own ratings and reviews on products during the course of their in-store shopping experience. It is extremely expensive for brick-and-mortar retailers to generate an amount of interest and traffic data at a product level that online retailers collect for free.

Retailers are looking to better attract shoppers to their store with a more compelling experience. They are challenged with providing the shoppers the information and advice they need in the store in a manner that is both effective and entertaining.

Customers go to a retail store to look for and learn about products. When the customers are in the store, they want to talk to an in-store sale representative to learn more about the products. Currently, the in-store customer representative is a rare and expensive resource. Usually, such representatives are difficult to find when the customer needs one, or the representative that is available may not be helpful due to lack of product familiarity.

Sales and customer satisfaction would increase dramatically if a customer has a knowledgeable sales representative available when looking for products or when the customer attempts to learn more about the features of a product. The obvious solution to this problem is for the retail store to hire more in-store sale representatives. However, it is not a cheaper or even easier solution.

### SUMMARY

A way for shoppers to readily access the information and advice they need on a product, right at the product, in a manner that is consistent with their in-store shopping experience is provided. This serves as a much more effective and entertaining channel for retailers to inform and interact with their shoppers within store environments. A way for consumers to readily access the information and advice they need about a product, right at the product, whenever and wherever they need the information is also provided. This also serves as a much more effective channel for retailers/manufacturers to inform and interact with the consumers of their products in the environments that the products and the consumers live in.

Present embodiments permit customers to have a sales representative to be with them when needed, either remotely or locally. The embodiments described herein provide a much lower cost, compared to hiring additional sales staff. Moreover, the present principles enable a much larger agent pool of knowledgeable product experts across all the stores in a chain via network (e.g., Internet), and may provide information of feedback by, for example, social networking. Further, the sale staff is better utilized and expertise of the sales staff is better exploited.

A system and method for providing contemporaneous product information includes identifying a product by collecting information with a user device, and determining a customer location using information collected by the user device. Based upon the product and the customer location, a sales person qualified to respond to customer questions is identified. A link is established between the customer and the sales person to permit live chat between a sales person and the customer.

A system/method for providing contemporaneous product information includes: identifying a product at a store location by collecting information from a user device; determining a customer location in the store using information collected from the user device; based upon the product and the customer location, identifying a sales person qualified to respond to customer questions from one or more sales persons available for questions in a help desk application; and establishing a network link between the customer and the sales person using the client device to permit live chat between the sales person and the customer.

A system for providing contemporaneous product information includes a server configured to collect product identity from a customer query. The server configured to communicate with at least one user device, the server including a help desk application configured to identify a sales person in accordance with a customer query which identifies a product, and determines a user location. A router is coupled to the server through a network and configured to locate a sales person identified by the help desk application such that a network link is established between the customer and the sales person using the user device to permit live chat between the sales person and the customer.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for providing contemporaneous product information using a sales person service where the sales person is remotely located or a remote request is made for local assistance in accordance with the present principles;

FIG. 2 is an illustrative diagram showing a plurality of methods for determining a customer's location in accordance with preferred embodiments; and

FIG. 3 is block/flow diagram showing a system/method for providing contemporaneous real-time live sales support in accordance with the present principles.

### DETAILED DESCRIPTION OF PREFERRED EMBODIMENTS

The present principles provide systems and methods for a retail store to capture a customer's location (e.g., the retail store identity and/or an in-store position) and customers' product interest effectively. The system employs the captured information to select an available “remote” agent to chat with. The remote agent is among agents shared by the retail store chain or individual store. Since the remote agent knows the retail store location and the customer location, the remote agent can direct an available in-store agent to walk to and help the customer if the remote agent himself is not able to answer the questions from the customer. Further, the remote agent can connect the customer to an information source such as a website, database, file or other media to obtain the requested information in real-time.

The present embodiments create an infrastructure to support such a method. The infrastructure is scalable to support all the retail stores across the globe and may be adapted to employ various languages. Another feature may include an application stored in customer's mobile device to support different kinds of the retail stores, that is, the user does not have to download different code for different stores.

In accordance with the present principles, product information is provided to a consumer at the product at the location in a store. In addition, product information and support may be provided to a consumer of the product over the product's lifetime using a similar sale support method.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

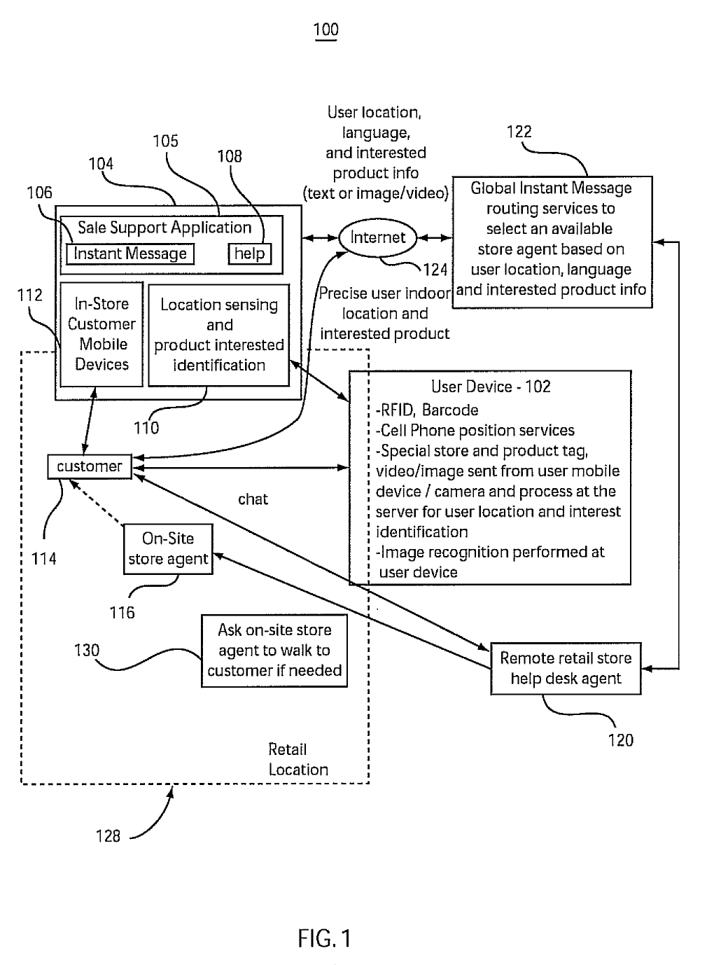

Referring now to the drawings in which like numerals represent the same or similar elements and initially to FIG. 1, a system architecture or infrastructure 100 is illustratively depicted for providing real-time customer support to customers. A customer 114 can go to a retail store or location 128. The customer 114 preferably has a product identification device 102 which can communicate with a network 124. The network 124 may include a local or global network, and the connection may be wired or wireless. The network 124 may be an in-store network with a direct connection or connections with a server 104.

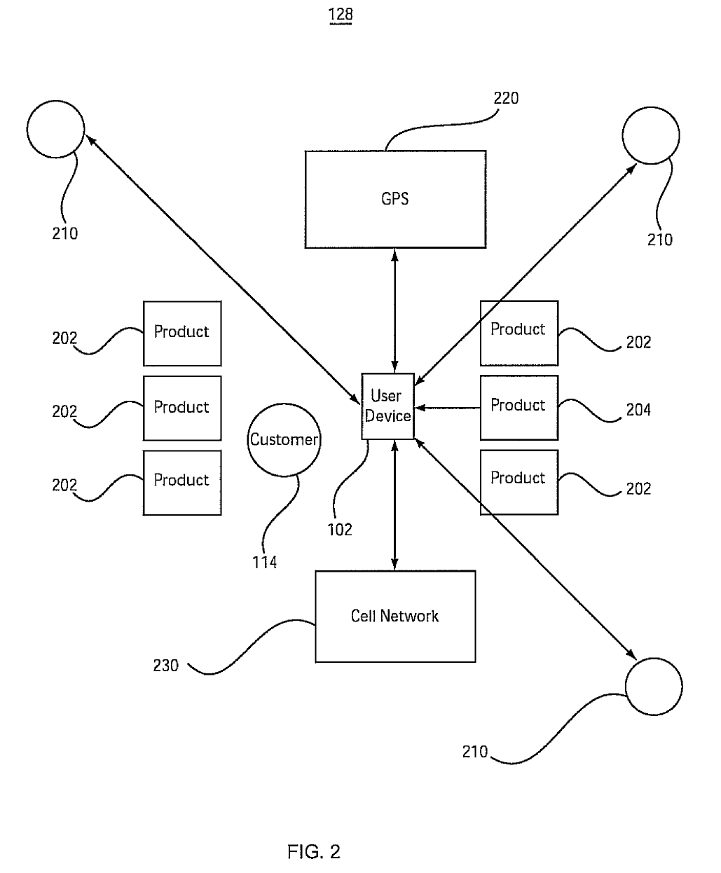

The user device 102 may include a RFID tag identifier, a bar code scanner, a camera or image capture device and preferably image processing/recognition software, or other product identification mechanism. The client device 102 may include a location identification device or service (see FIG. 2), such as a global position system (GPS), a signal strength determination mechanism or other configuration capable to provide location information for the user device 102 or customer 114. The user device 102 may include a cell phone, personal digital assistant, a specialized device provided in accordance with this application, etc.

In one embodiment, using a camera to shoot an image of a store logo or name, the system 100 recognizes the retail location 128 and prompts the customer 114 that an application for real-time sales support is enabled and that the store location is identified (from the positioning information). The user location can be automatically obtained directly by other means, for example, a cell phone location service, etc.

User device 102 may include a user's handheld device, such as a cell phone, personal digital assistant, customized device or any other suitable scan device. The device 102 may be provided to a user at the store and returned when the user has completed their shopping. The device may be connected to or be part of a shopping cart, among other things.

The device 102 may include an image acquisition module. This may include a camera, a bar code scanner or the like capable of reading identifying information about a product. Once scanned the image is detected by a detection module 110. This module 110 uniquely identifies the product. This may be performed using a UPC code, bar code, RFID, image recognition or other technology.

When a user/customer 114 is interested in getting help for a product, the customer 114 can use the user device 102 (e.g., a cell phone with a camera) to point to a special design pattern or identifying indicia attached to the product, and the image or video is sent to a server 104 and/or application 105 for processing. The server 104 includes a location sensing and product identification module 110. These functions may be separate but are described here together. Once the product is identified, the server 104 will prompt the user that product identification has been obtained.

It should be understood that the server/application 104/105 may be located at the retail store 128 where the customer is located or may be located remotely or may be part of a distributed network at the retail location and other places.

The product identification can also be directly obtained from RFID, barcode or other identification system, if available. In one embodiment, retailers attach small unique markers to products such as a distinct pattern, a two-dimensional bar code, etc., which can be recognized through visual recognition software that takes an image of the product. When a shopper/consumer points a cell phone camera at this product/marker, information about the product such as product summary, support information, reviews, sales, etc., are obtained dynamically from the retailers/manufacturers' back-end systems (e.g., server 104) and/or the Internet 124. The product identification information is conveyed by the shopper/consumer through the shopper/consumer's cell phone or device 102 to the server 104 or directly over the network 124. The product may be identified at the user device 102, at the server 104 or using the Internet 124. Using the product identification information and the location of the product, a salesperson can be identified at the server 104. A client inquiry message or request is sent to a remote help desk agent 120. This may be performed in many ways. In one example, a global instant messaging router 122 (or other communication mechanism) is employed to route the message to the remote help desk 120. The instant messages, calls or other requests are forwarded to the remote retail store help desk agent 120. Alternately, an image of the product may be sent directly to a sales person (e.g., as an attachment to a query, or message), and the sales person may identify the product on their own.

The server 104 may include a help or help desk application 108 as well, which may include a table or other correlation method, which assigns available sales people with products. In this way, for a product query, it can be determined which store and which agent or sales person would be best suited to answer a particular query. This would be helpful in routing a specific inquiry to a specific sales person. Also, sales people may be assigned locally in the store.

A scoring method may be employed to score a sales person most likely to be able to help a customer. For example, if a sales person SP is an expert on product A in store 1, and a customer has a question regarding a related product B in store 1, the scoring method may identify SP as the most likely salesperson to properly answer the customer question since SP would be the “closest” score-wise to the product. The scoring method may consider among other factors store location, sale expertise, product type, manufacturer and any other relevant information.

Server 104 supports communications protocols and applications, such as, e.g., instant messaging 106. Other mechanisms include video conferencing, email, telephone calls, text messages, etc.

In one embodiment, the user's action for obtaining product information may be employed to log a user onto a retailer's or manufacturer's server 104. This may be performed by an application stored on a user's device 102. The application may include opening a menu option to obtain sales information or to scan a marker. In one alternate embodiment, a product code may be present on the product or on the store display that enables the server to decipher both the product type and the user's location. This code may be entered by the user, scanned by the user, etc.

A user's location inside the store can also be obtained by using the product information (the product location in the store may be determined based on a store map, product location information or from a Wi-Fi triangular mechanism if Wi-Fi access points are available in the retail store (see e.g., FIG. 2). A user's preferred language can also be obtained from the user's input or based upon the location of the store.

Based on the customer's information (retail store location, in-store location, product of interest (interested product), and language), the system 100 provides help to the customer in the following ways. The system 100 can help find an available agent in an agent pool and let this remote agent 120 talk/chat with the customer 114 directly (if the remote agent 120 has enough knowledge about the product interested). The remote agent 120 can route a request 130 to a local or on-site agent 116 in the same store 128 as the customer 114 to help (e.g., a face-to-face chat). The local agent 116 may be provided with location information for the customer's location from the remote agent 120 to make the customer 114 easier to find. The remote agent 116 may route the request 130 to a local agent in a different store or other location to help the customer 114 via phone or other device.

Using this mechanism, the customers 114 can reach an agent (120, 116) anywhere and anytime by using Instant messaging 122 or other technology routed through a network such as the Internet 124. An agent pool can be decentralized, for example, each store can have its own set of agents to speak with a customer about a question or questions related to products or services. In this example, an agent 116 or 120 does not have to walk directly to the customer 114, and the customer 114 does not have to wait for the agent nearby to become available. In addition, since the product, department or area of expertise needed can be determined from the customer request, the most suitable or most suitably available agent can be identified and employed to answer the question.

The remote agent 120 can transfer the chat to an in-store agent 116 and ask the in-store agent to approach the customer when needed since the agent will know the customer's location. Every qualified person can be classified and function as an agent in some specialized topic and/or area for routing the customer's question. All agents 116 in the local stores can be connected by the remote agent 120, and the requests 130 can be routed to these people as a part of the network. This effectively increases the size of the agent pool and can provide service to more customers and more efficiently in real-time.

In one embodiment, the server 104 employs the location sensing and product identification to respond directly to in-store agents 116 using a mobile device(s) 112. In this example, the customer 114 may request in-store help directly and the mobile device 112 may be employed to speak with the customer 114 through the user device 102. The in-store agent may be requested to respond directly to a customer's request for service. A user option may permit a request for either in-store assistance, remote assistance or a combination of both.

Referring to FIG. 2, in-store customer location systems are illustratively depicted. In one embodiment, locators 210 are employed in a particular location and signal measurements can be made to a user device 102 of a customer 114. The signals may include transmission signals, such as pilot signals or employ signal strength measurements. The locators 210 are preferably spaced apart and triangulate on a customer position. The locators 210 may be included in a Wi-Fi type system for local position determination.

Other location mechanisms may also be employed. For example, in an alternate embodiment, a GPS location system 220 may be employed to determine a position of a customer in the store. In another embodiment, a cell network 230 is employed to determine a position of the customer in the store. Such technology is known to those skilled in the art.

The shopper/consumer could also add their own ratings and reviews on a product at any time—thus making a store environment or their own home or office environment into a virtual multimedia web log (blog). This information flows back to the retailers/manufacturers and may be used as feedback for other shoppers/consumers, enabling new “in-situ” reviews and ratings of products. Feedback on sales people may also be permitted in this way as well.

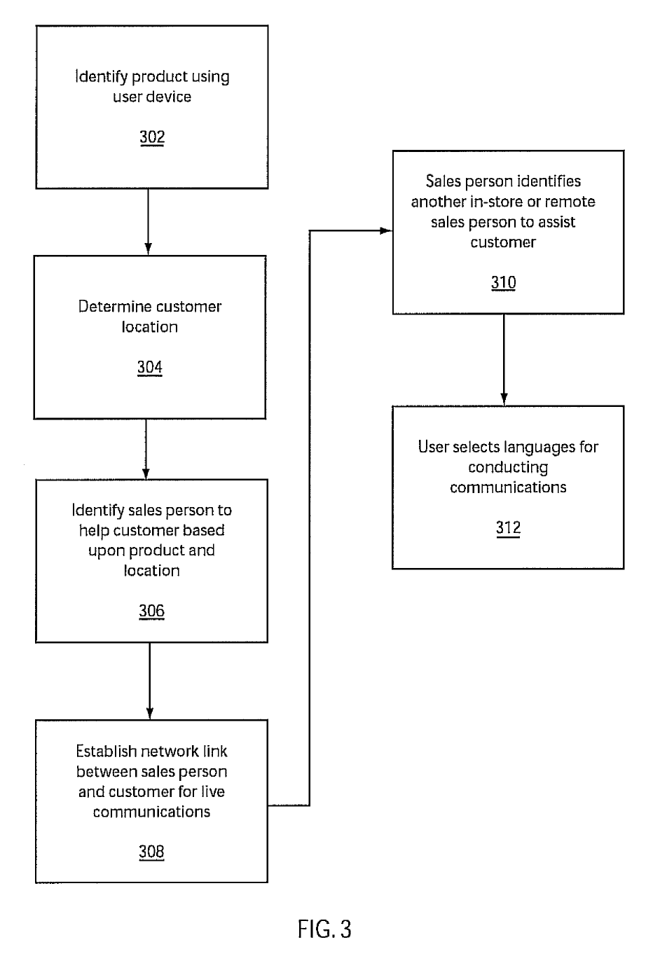

Referring to FIG. 3, a system/method for providing contemporaneous product information is illustratively described in accordance with one exemplary embodiment. In block 302, a product is identified at a store location by collecting information from a user device. The user device may include a cellular telephone, a personal digital assistant, a walkie talkie, or any other two-way communication device. Identifying a product may include a plurality of methods, e.g., in one example, an image is acquired with a camera of the user device and image recognition is employed to identify the product, or the image is sent to a sales person and identified by the sales person. In another example, a bar code is scanned with the user device to identify the product. The identity of the product may be performed in conjunction with an application loaded on the user device which enables interfacing and interacting with the server and/or the network of the system. For example, the customer may activate the inquiry program and step by step instructions may be displayed. For example, after activating the program, the device display will inform the user of one of the available methods for identifying the product. The user will select an appropriate choice and perform the collection of information. Information will be collected automatically or manually. This information will be sent to the server or over a network to be processed. A communication link will be established to provide the further aspects as described hereinafter.

In block 304, a customer location is determined in the store using information collected from the user device. This may include an entered code by the user, global positioning, cellular location, a local triangulation system, etc. In block 306, based upon the product and the customer location, a sales person qualified to respond to customer questions is identified from one or more sales persons available for questions using a help desk application. In block 308, a network link is established between the customer and the sales person using the client device to permit live chat between the sales person and the customer. This may include using a help desk agent to route the inquiry or relay information to the customer.

In block 310, the sales person is remote from the in-store location and identifies another remote sales person at a remote location or an on-site sales person to assist the customer. This may be pursuant to a customer request. The link and communications may include one or more of an instant message, a telephone call, a video conference, an email, a text message, etc. In block 312, a user request may include a language selection by the customer, in which to conduct further communications.

Having described preferred embodiments of a system and method for providing contemporaneous product information and sales support for retail customers (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for providing contemporaneous product information, comprising:
identifying a product by collecting information with a user device;
determining a customer location using information collected by the user device;
based upon the product and the customer location, identifying a sales person qualified to respond to customer questions; and
establishing a link between the customer and the sales person to permit live chat between a sales person and the customer.

2. The method as recited in claim 1, wherein identifying a product includes acquiring an image with a camera of the user device and employing image recognition to identify the product.

3. The method as recited in claim 1, wherein identifying a product includes scanning a bar code with the user device.

4. The method as recited in claim 1, wherein determining a customer location includes using one of global positioning, cellular location, an entered code and a local triangulation system.

5. The method as recited in claim 1, wherein identifying a sales person includes identifying a sales person at a remote location and establishing a link includes establishing a link over a network to permit live chat between the remote sales person and the customer.

6. The method as recited in claim 5, wherein the remote sales person requests an on-site sales person to assist the customer.

7. The method as recited in claim 1, wherein establishing a link between the customer and the sales person includes one or more of an instant message, a telephone call, a video conference, an email, and a text message.

8. The method as recited in claim 1, further comprising requesting a language, by the customer, in which to conduct communications.

9. A computer readable medium comprising a computer readable program for providing contemporaneous product information, wherein the computer readable program when executed on a computer causes the computer to:
identifying a product by collecting information with a user device;
determining a customer location using information collected by the user device;
based upon the product and the customer location, identifying a sales person qualified to respond to customer questions; and
establishing a link between the customer and the sales person to permit live chat between a sales person and the customer.

10. A method for providing contemporaneous product information, comprising:
identifying a product at a store location by collecting information from a user device;
determining a customer location in the store using information collected from the user device;
based upon the product and the customer location, identifying a sales person qualified to respond to customer questions from one or more sales persons available for questions in a help desk application; and
establishing a network link between the customer and the sales person using the client device to permit live chat between the sales person and the customer.

11. The method as recited in claim 10, wherein identifying a product includes one of acquiring an image with a camera of the user device and employing image recognition to identify the product, and scanning a bar code with the user device.

12. The method as recited in claim 10, wherein determining a customer location includes using one of global positioning, cellular location, an entered code and a local triangulation system.

13. The method as recited in claim 10, wherein the remote sales person identifies one of another remote sales person at a remote location and an on-site sales person to assist the customer.

14. The method as recited in claim 13, wherein establishing a network link between the customer and the sales person includes one or more of an instant message, a telephone call, a video conference, an email, and a text message.

15. The method as recited in claim 10, further comprising requesting a language, by the customer, in which to conduct communications.

16. A computer readable medium comprising a computer readable program for providing contemporaneous product information, wherein the computer readable program when executed on a computer causes the computer to perform the steps of claim 10.

17. A system for providing contemporaneous product information, comprising:
a server configured to collect product identity from a customer query, the server configured to communicate with at least one user device, the server including a help desk application configured to identify a sales person in accordance with a customer query which identifies a product, and determines a user location; and
a router coupled to the server through a network and configured to locate a sales person identified by the help desk application such that a network link is established between the customer and the sales person using the user device to permit live chat between the sales person and the customer.

18. The system as recited in claim 17, wherein the at least one user device includes one of a cell phone, a personal digital assistant, and a specialized marker detection device.

19. The system as recited in claim 17, further comprising a customer-specified language form communicating with the sales person.

20. The system as recited in claim 17, wherein the server includes a module for location sensing and product identification configured to determine a customer location and identify a product of interest for use in identifying a sales person using the help desk application.

21. The system as recited in claim 20, wherein the sales person is identified based upon a scoring method.

22. The system as recited in claim 17, wherein one of global positioning, cellular location, an entered code and a local triangulation system is employed to determine customer location.

23. The system as recited in claim 17, wherein the sales person identifies one of another sales person at a remote location and an on-site sales person to assist the customer.

24. The method as recited in claim 17, wherein the network link between the customer and the sales person provides communication which includes one or more of an instant message, a telephone call, a video conference, an email, and a text message.
